(19) United States
(12) Patent Application Publication
(10) Pub. No.: US 2004/0136365 A1
(43) Pub. Date: Jul. 15, 2004

(54) Exchange for establishing connections and corresponding method

(76) Inventors: Herwig Eltschka, Starnberg (DE); Norbert Lobig, Darmstadt (DE)

Correspondence Address: MORRISON & FOERSTER LLP, 1650 TYSONS BOULEVARD, SUITE 300, MCLEAN, VA, 22102, US

(21) Appl. No.: 10/475,532

(22) PCT Filed: Apr. 3, 2002
(86) PCT No.: PCT/DE02/01209

(30) Foreign Application Priority Data
Apr. 23, 2001 (DE) 101 19 795.0

(51) Int. Cl. H04Q 11/00; H04L 12/50

(52) U.S. Cl. 370/359; 370/374

(57) ABSTRACT

The invention relates to an exchange (12) and a method for controlling an exchange (12) for establishing connections. Said exchange (12) is connected to at least one separately arranged connection unit (14) to which n connection groups (40a, 40b) are connected. The connection between the separately arranged connection unit (14) and the exchange (12) is established by means of transmission interface units (16, 18) of the separately arranged connection unit (14) and the exchange (12). The connection between the transmission interface unit (18) of the exchange (12) and the coupling network (32) of the exchange (12) is established by means of x useful data channels, the sum of the transmission capacities of said x useful data channels being smaller than the sum of the transmission capacities of the useful data channels of all n connection groups (40a, 40b).

The invention relates to an exchange for the switching of connections, wherein the exchange is connected to at least one remotely located line unit. The connection between the remotely located line unit and the exchange is established by means of a transmission interface unit of the remotely located line unit and a transmission interface unit of the exchange. This connection includes p message data channels and m user data channels. In the exchange, there is additionally a connection between the transmission interface unit and a switching network of the exchange.

A previously disclosed exchange has central units such as, for example, a central computer platform, a message buffer device, a switching matrix, secondary storage, input and output units, and protocol termination devices (e.g. #7). Such an exchange also has line/trunk groups for subscribers and lines. The line/trunk groups are also designated as peripheral devices. As shown in prior art, subscribers or connection lines to remote exchanges can be attached to the exchange by means of such line/trunk groups, e.g. via concentrators. In a telecommunication network, such an exchange is also referred to as a switching node.

The line/trunk groups perform switching-oriented tasks, in particular switching-oriented tasks which relate to the voice channels of the peripheral devices. They contain switching-oriented, operation-oriented and administrative program modules and data information, such as line location, signaling, class of service data, call numbers, individual characteristics of connection lines and subscriber lines, as well as the expansion level and the configuration of the line/trunk group.

The central computer platform of the exchange has a coordination processor which services program modules for controlling the connection setup and the connection cleardown and for responding to administrative and error-related configuration changes of the exchange. The line/trunk groups are connected to this shared computer platform via the message buffer system. The computer platform also interconnects the line/trunk groups. Further central units, such as switching matrix, protocol termination devices, secondary storage and input and output devices, provide the switching system with special functions for the through-connecting of voice channels, the processing of signaling protocols, the implementation of the operator interface, or the storing of bulk data. Central components of the switching system are configured with redundancy, i.e. these components are generally duplicated. As a rule, the line/trunk groups are not configured redundantly. However, if it is desirable to ensure a high level of fault resilience in the line/trunk groups, these can also be redundantly configured. By using redundant line/trunk groups it is possible to maintain connections even in the event of a failure of a line/trunk group.

Smaller or older local exchanges are increasingly being replaced by one larger exchange which has remotely located line units, so-called RSUs (remote switching units), at the locations of the replaced exchanges. Such a separate line unit is also designated as a concentrator center. The remotely located line units have a switching matrix, line/trunk groups, and an interface for the data transmission to the exchange. In such an arrangement, the exchange is also known as the parent exchange. The control of the remotely located line unit takes place by means of the control unit of the exchange, i.e. by means of the central computer platform of the exchange. The switching of connections between the line/trunk groups takes place via the switching network of the parent exchange and via the switching matrix of the remotely located line unit, or by bypassing the switching network of the parent exchange. When connections are switched only by means of the switching matrix of the remotely located line unit, the volume of user data between the exchange and the remotely located line unit is reduced, and therefore the number of connections to be switched by the switching matrix is reduced. Parts of the exchange, in particular parts of the switching network and connections to the switching network, are lightly loaded.

The object of the invention is to specify an exchange and a method for operating an exchange, wherein the cost of constructing the exchange is reduced.

This object is achieved for an exchange by the features of Claim 1 and for a method by the features of Claim 32. Advantageous developments are specified in the dependent claims.

In an exchange having the features recited in Claim 1, it is possible to reduce the hardware cost involved in the construction of the exchange. It is possible to cut down on the number of modules and racks, in particular of the switching network of the exchange, by reducing the number of transmission channels. By reducing the number of transmission channels between transmission interface unit and switching network it is also possible to cut down on the number of modules of the transmission interface unit and connection lines between transmission interface unit and switching network. A bidirectional and sufficiently performant transmission of control data and reports between each line/trunk group and the exchange is ensured by means of the p message data channels.

In the prior art, however, one connection is provided in each case between the transmission interface unit and the switching network for the user data channels of each of the n line/trunk groups. Due to the switching of internal connections outside the switching network, e.g. in the remotely located line unit, the user data channels between transmission interface unit and switching network are not loaded or are only lightly loaded. In a further known embodiment, the transmission capacity between the transmission interface unit of the remotely located line unit and the transmission interface unit of the exchange is less than the sum of the user data channels of all n line/trunk groups of this remotely located line unit. Therefore, in this known embodiment, all of the existing user data channels between the transmission interface unit of the exchange and the switching network of the exchange are never fully utilized, even if there is a corresponding requirement from the line/trunk groups.

In distributed telecommunication networks, a plurality of line/trunk groups are directly connected to the exchange, as are a plurality of remotely located line units having further line/trunk groups. In this case the exchange can be a parent exchange, e.g. of a local network, and the remotely located line units can be so-called RSUs (Remote Switching Units) which are also designated as concentrator centers.

It is also advantageous that connections which are to be switched between and within the n line/trunk groups of a remotely located line unit are switched within the remotely located line unit, e.g. by means of a switching matrix of the remotely located line unit. In a further embodiment, a plurality of remotely located line units are attached to a transmission interface unit of the exchange. Connections between the line/trunk groups of different remotely located line units which are attached to this transmission interface unit are then switched by means of the switching matrix of the transmission interface unit. This reduces the number of connections that are switched by means of the switching network of the exchange, and therefore reduces the volume of data to be transmitted via the switching network of the exchange.

In a development of the invention, for the purpose of standardization and therefore simplified modular construction, the connection between each of the n line/trunk groups and the remotely located line unit comprises k user data channels and one message data channel. In a further embodiment, it is also possible, e.g. for covering complex control and reporting tasks or if the transmission links are redundantly configured, to provide two or more message data channels whose transmission capacity is a multiple of a fixed basic data transmission capacity of the switching system, said multiple being defined for each line/trunk group.

In a further development, the sum of the transmission capacities of the message data channels of the n line/trunk groups is less than or equal to the sum of the data transmission capacities of the p message data channels between the transmission interface units of the exchange and the remotely located line unit. In this way, at least one permanently preset message data channel is present for each line/trunk group. Further message data channels are possible, e.g. for controlling the remotely located line unit. The message data which is transmitted by means of the message data channels contains control commands and reports which the line/trunk groups exchange among themselves and with central components of the exchange. This message data can be used for controlling switching-oriented, administrative and/or configuration-related events.

In an advantageous development of the invention, for implementing the message data channels between the exchange and the remotely located line unit, transmission capacities are provided between the transmission interface units of the exchange and the remotely located line unit. The data transmission between exchange and remotely located line unit can therefore take place by means of standard transmission links which are used equally for user data and message data, e.g. by means of PCM30, PCM24, SDH or SONET transmission links. In this way, the data of the message data channels can be transmitted bidirectionally in the exchange, between the transmission interface unit and a message buffer. Within the exchange, the transfer of message data containing in particular control data and reports can therefore be achieved easily and by means of a uniform method.

It is also advantageous if the transmission capacity of each user data channel and each message data channel is a multiple or a fixed multiple of a basic data transmission rate, since a simple and uniform multiplex structure is then possible in the exchange and in the remotely located line unit.

In one embodiment, the switching network of the exchange is used for transferring message data between the transmission interface unit of the exchange and the message buffer. Fixed connections are switched between the message buffer and the transmission interface unit of the exchange by means of the switching network. These connections include in particular the message data channels and are permanently preset. By using the software and hardware components of the switching network, the message data can be transmitted easily and without additional hardware cost in the exchange between the message buffer and the remotely located line unit of the exchange.

In a further development, a further message data channel is provided for transmitting message data in each case, for control purposes and for reports of the transmission interface unit of the exchange on one hand, and for control purposes and for reports of the transmission interface unit of the remotely located line unit on the other. As a result of using message data channels, a uniform method is possible for these devices and for all line/trunk groups for the purpose of message transmission from and to the transmission interface units.

In a development of the exchange as claimed in the invention, a special physical interface is provided between the transmission interface unit of the exchange and the message buffer. Maximum flexibility of the exchange is thereby achieved in relation to the message data transmission rates which are required, since there is independence from the through-connecting capacity of the switching network. As an alternative, the existing interface between the switching network of the exchange and the transmission interface unit of the exchange can be used for message transmission. In this way, the interfaces which are already present in any case can also be used for transmitting message data. This eliminates the cost of installing and implementing further interfaces.

In a further embodiment, the switching network switches bidirectional, permanently defined message data channels in order to transmit the message data between a message buffer and the transmission interface unit of the exchange. In this way, when a line/trunk group of a remotely located line unit is set up or started up, the controller or coordination processor of the exchange searches, by means of a path-finding algorithm, for a through-connecting path for the relevant message data transmission channel between the message buffer and the line/trunk group, through-connects this through-connecting path, including the required transmission channel, between the exchange and the remotely located line unit, permanently occupies said through-connecting path, and activates it at the startup of the line/trunk group at the latest. This guarantees message data transmission at all times for activated line/trunk groups of the remotely located line unit.

In an advantageous development of the invention, the controller of the exchange works according to a path-finding algorithm which prefers through-connections between the n line/trunk groups of a remotely located line unit and within one of the n line/trunk groups to be made via a front-end switching matrix of the remotely located line unit. The volume of user data to be transmitted between the exchange and the remotely located line unit is thereby reduced when such a path-finding algorithm is used for connection control.

In a further development of the exchange as claimed in the invention, each line/trunk group has a logical address for exchanging message data with other devices belonging to the exchange. This logical address of the line/trunk group is always used for addressing message data and, for example, for switching user data connections. In this case, the logical addresses are managed by a coordination processor and the message buffer system of the exchange. The logical addresses are assigned to the line locations of the switching network. These cannot be upgraded with hardware modules. The logical addresses of the line/trunk groups, said logical addresses being managed by the exchange, therefore correspond to a switching network, and the non-upgraded hardware modules form virtual components of this switching network. Therefore it is not essential for these hardware components to be supplied, in particular in the case of line/trunk groups in remotely located line units, and consequently less space is required in the exchange, and procurement and operating expenditures are reduced.

In a further development of the invention, the message buffer system and the switching network of the exchange are constructed in the same way as in the case of a direct connection of all line/trunk groups to the switching network. A part of the switching network of the exchange is not physically upgraded in this development of the invention. The data transmission to line/trunk groups which are directly connected to the switching network and to the transmission interface units which are connected to the switching network is then effected by means of the physically upgraded part of the switching network. The parts of the switching network which are not physically upgraded can be set up as virtual components of the switching network via an operating interface of the exchange, and identified as virtual components in a database of the exchange. Consequently, reports following faults in components that are present at hardware level in the exchange, which reports also contain the status of associated virtual subcomponents of the exchange, can be adapted in such a way that they automatically identify the virtual subcomponents by means of the comment “virtual component”. The operating staff and maintenance personnel are thus informed that consideration of the non-virtual parts is sufficient for fault clearance. Malfunctions or faults of the hardware modules identified as virtual are ruled out since these hardware modules are not present.

In a further embodiment, those components of the switching network which are identified as virtual are not started up in hardware at a startup or a partial startup of the exchange. The setting up of line/trunk groups which are assigned to these virtual parts of the switching network, and the startup of these line/trunk groups, is allowed if the line/trunk groups are part of a remotely located line unit of the exchange.

The message interfaces of the line/trunk groups which are assigned to virtual components of the switching network to further modules and elements of the telecommunication network remain entirely the same, and the line/trunk groups which are attached to the remotely located line unit can continue to be polled, addressed and controlled in exactly the same way as line/trunk groups which are connected directly to the switching network of the exchange. Therefore a multiplicity of existing software and hardware components can continue to be used without modification in such an exchange. There is no requirement for modifications to software and hardware components of further exchanges which are connected to this exchange in a telecommunications network.

By means of a method for controlling an exchange, said method having the features recited in Claim 32, it is possible to reduce the cost of hardware in the exchange, thereby cutting down on expenditure relating to procurement, installation and operation, and to reduce the amount of space required for the exchange.

Further features and advantages of the invention are disclosed in the following description, which explains the invention with reference to exemplary embodiments and with reference to the appended drawings, in which:

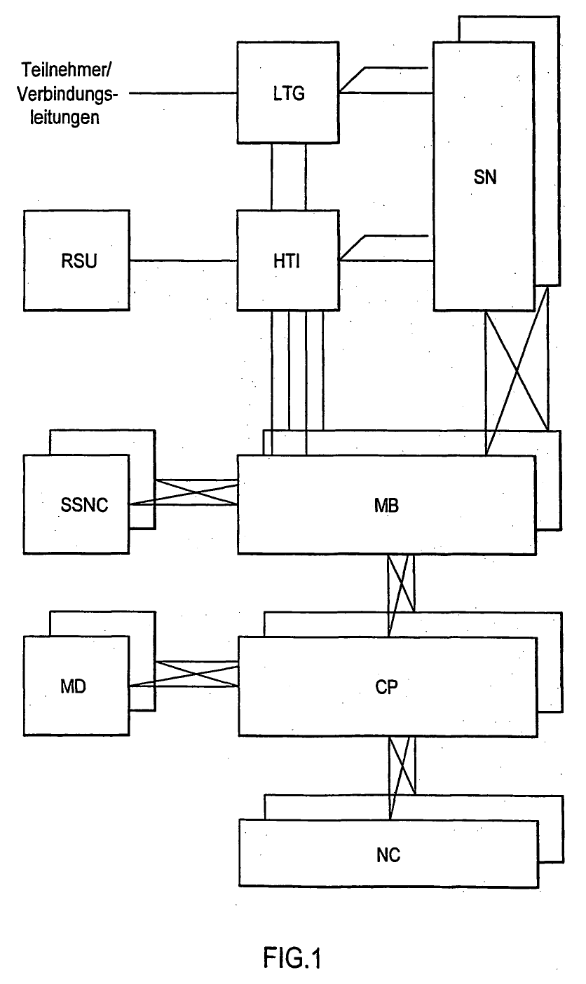

FIG. 1 shows a typical architecture of a known switching system having non-redundant line/trunk groups,

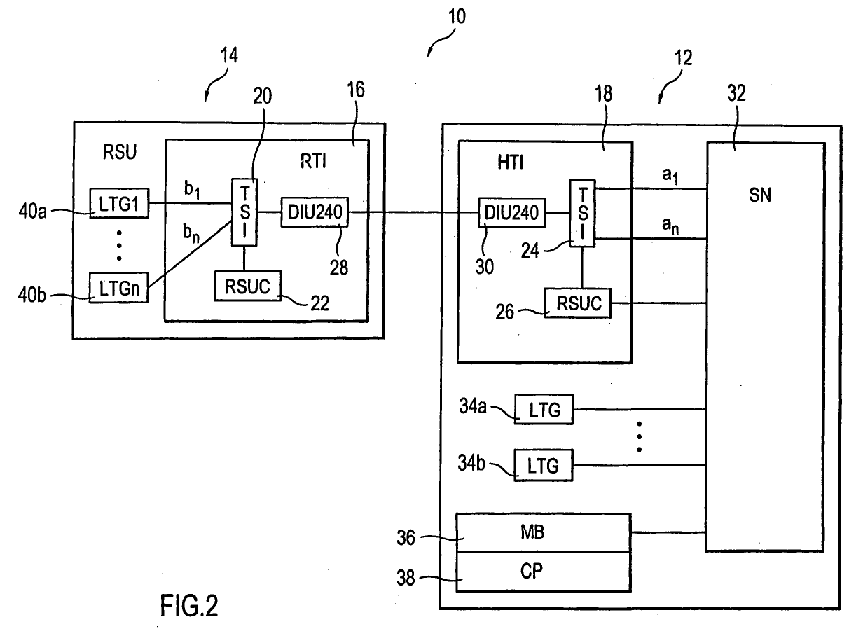

FIG. 2 shows an exchange and a remotely located line unit,

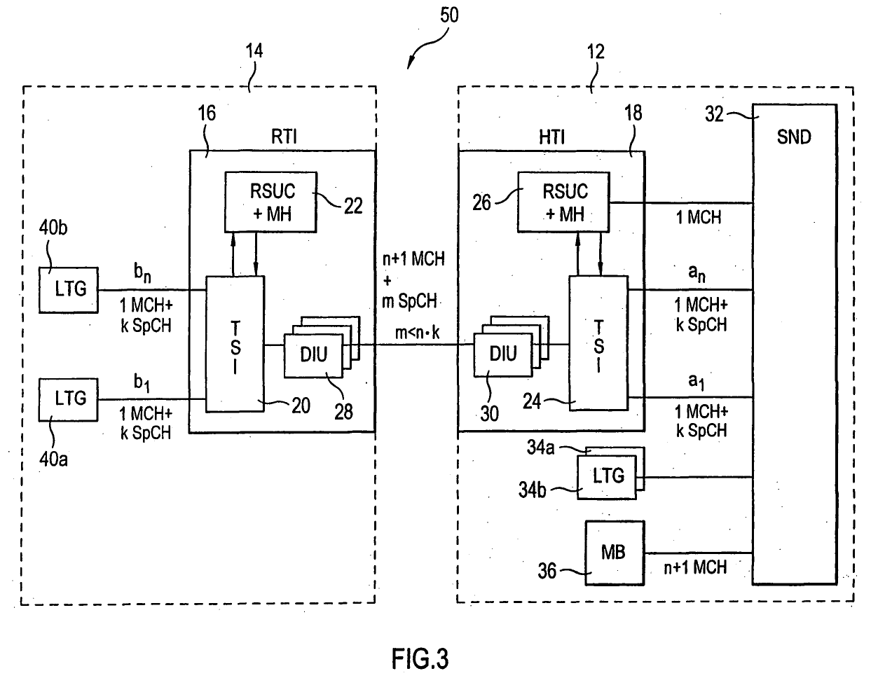

FIG. 3 shows a remotely located line unit and an exchange with a more detailed representation of user data channels and message data channels,

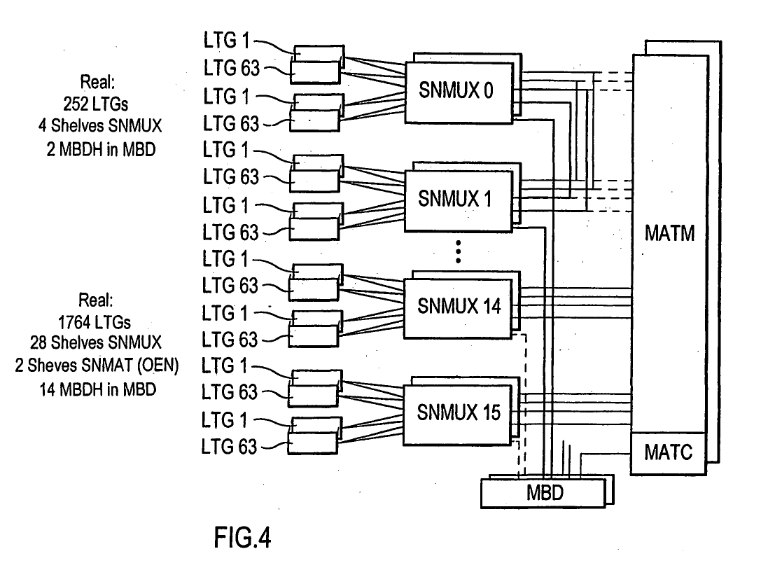

FIG. 4 shows virtual parts of a switching network having real line/trunk groups,

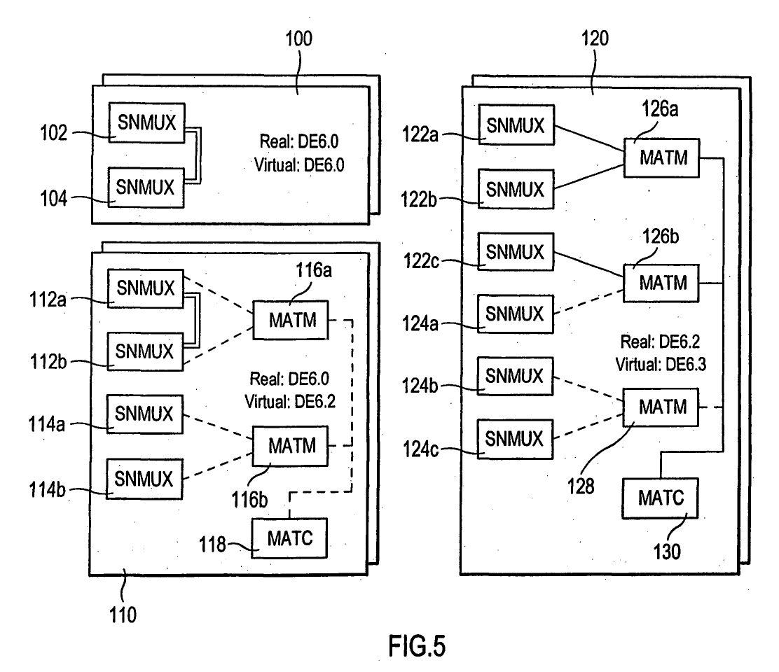

FIG. 5 shows various exchange upgrade levels which include virtual devices,

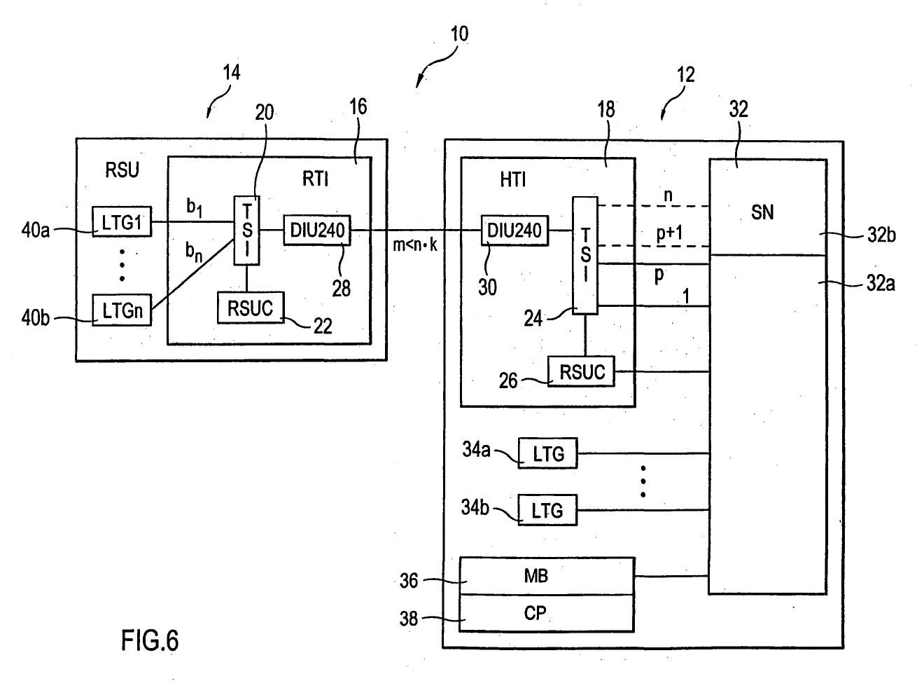

FIG. 6 shows a remotely located line unit and an exchange, wherein parts of the switching network of the exchange are constructed virtually,

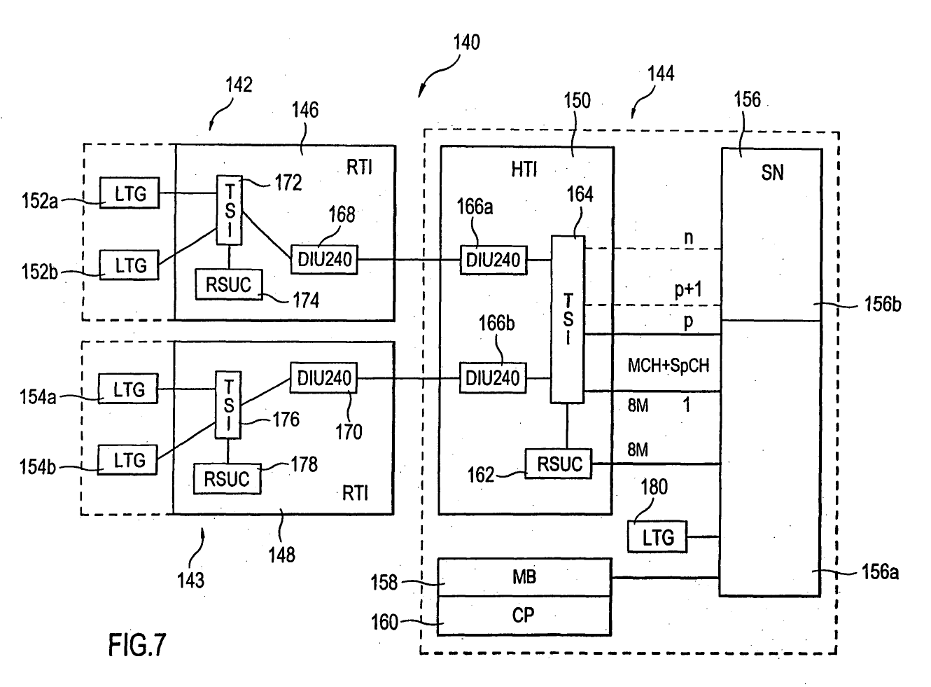

FIG. 7 shows an exchange to which a plurality of remotely located line units are connected via the same transmission interface unit, wherein a part of the switching network of the exchange is constructed virtually, and

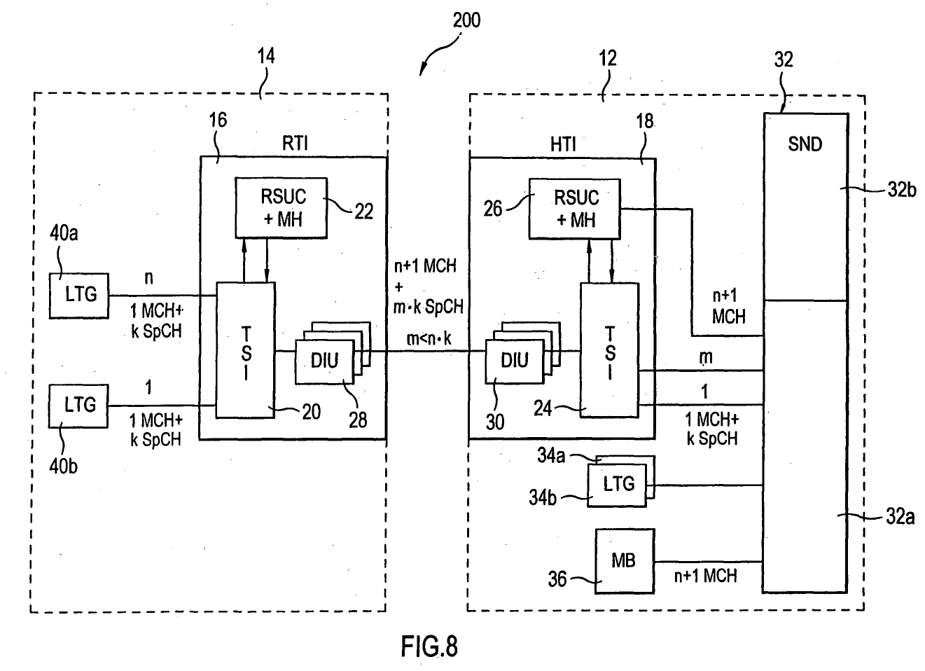

FIG. 8 shows a further remotely located line unit which is connected to an exchange, wherein parts of the switching network of the exchange are constructed virtually.

FIG. 1 shows a typical architecture of a switching system. Such a switching system has a switching network SN, a message buffer MB, a coordination processor CP, operating facilities NC, secondary storage MD and protocol termination devices SSNC (e.g. #7). These elements of the switching system are configured with redundancy, i.e. duplicated, in order to increase fault resilience. The switching system additionally has line/trunk groups LTG (line/trunk group) which are connected to the switching network SN and the message buffer MB. The line/trunk groups LTG are also designated as peripheral units and are used for attaching subscriber and connection lines. Remotely located line units RSU (remote switching unit) are additionally attached by means of transmission interface units HTI of the exchange. If no increased demands are placed on the switching-oriented availability of the subscriber and connection lines of the switching system, the line/trunk groups LTG or the remotely located line units RSU are not configured with redundancy.

FIG. 2 shows a further known switching system 10 in which a remotely located line unit 14 is connected to an exchange 12, a so-called parent exchange. The remotely located line unit RSU 14, which is also designated as a concentrator center, has a transmission interface unit RTI 16 which is connected to a transmission interface unit HTI 18 of the exchange 12 by means of interface modules 28, 30. The transmission interface unit RTI 16 of the remotely located line unit RSU 14 has a switching matrix TSI 20 and a control unit 22. Line/trunk groups LTG 40a, 40b are connected to the switching matrix TSI 20 of the remotely located line unit RSU 14 by means of link lines b₁ and bₙ, wherein the line/trunk group LTG1 and the line/trunk group LTGn which are designated as 40a and 40b are shown by way of example for further line/trunk groups. Each of these link lines has transmission channels for user data and transmission channels for message data. The transmission interface unit HTI 18 of the exchange 12 has a switching matrix TSI 24 and a control unit 26. The switching matrix TSI 24 and the control unit 26 are connected to a switching network SN 32 of the exchange. Two line/trunk groups LTG 34a, 34b are directly connected to the switching network SN 32.

The exchange 12 has a message buffer MB 36 and a coordination processor CP 38. The processes for switching of connections in the exchange 12, in the remotely located line unit RSU 14 and in the line/trunk groups LTG 40a, 40b are controlled by means of the coordination processor CP 38. Control messages are transmitted via the switching network SN 32 to the corresponding components of the switching system 10 by means of the message buffer MB 36. In this way, the coordination processor CP 38 also controls connections which are switched from and to the line/trunk groups LTG 40a, 40b of the remotely located line unit RSU 14. The transmission interface units HTI, RTI, 16, 18 are primarily used to connect the remotely located line unit RSU 14 to the exchange 12. The transmission interface unit RTI (remote timeslot interchange) 16 is a part which is located in the remotely located line unit RSU 14, and the transmission interface unit HTI (host timeslot interchange) 18 is an exchange-internal part for connecting line/trunk groups LTG 40a, 40b. The switching matrix TSI 24 of the transmission interface unit HTI 18 is connected to the switching network SN 32 by means of n connection lines, wherein two of these connection lines are designated a₁ and aₙ. A connection a₁, aₙ, e.g. an electrical or optical cable, to the switching network SN 32 is therefore provided for each line/trunk group LTG 40a, 40b of the remotely located line unit RSU 14. The same upgrade of the exchange 12 and of the switching network SN 32 is therefore required as in the case of a direct connection of the line/trunk groups LTG 40a, 40b to the exchange 12.

When modifying and upgrading telecommunication networks, it is common practice to replace a plurality of small exchanges with a new larger exchange 12. In order that the existing subscriber lines can continue to be used, it is advantageous if the remotely located line units 14 to which the previously used subscriber and connection lines as well as the previous line/trunk groups 40a, 40b are attached are located in the other former exchanges. In such cases, the remotely located line unit 14 is connected to the exchange 12 by means of interfaces, e.g. a DIU240 interface 28, 30. Such a configuration is advantageous with regard to costs of the retrofit of exchanges and to the operating costs which are incurred.

FIG. 3 shows a further known switching system 50 having an exchange and a remotely located line unit 14 similar to the switching system 10 in FIG. 2. The same elements have the same reference numerals. Each line/trunk group 40a, 40b which is connected to the remotely located line unit 14 by means of the connection lines b₁ and bₙ respectively has available for the purpose of data transmission k channels for user data and one message data channel for control data and reports. However, the connection between the exchange 12 and the remotely located line unit 14 by means of the interfaces 28, 30 has a transmission capacity of only m user data channels, where m<n×k. In addition to these m user data channels, n+l channels are available for transmitting message data between the remotely located line unit 14 and the exchange 12. In this context, communication between the message buffer [sic] 30 and the line/trunk group 40a, 40b which is to be controlled in each case takes place by means of message data channels. A further message data channel is provided for communication between the exchange 12 and the transmission interface unit 16 of the remotely located line unit 14.

It is possible to reduce the data transmission capacity between the exchange 12 and the remotely located line unit 14 to m voice channels, since concurrent use of all the available voice channels by the line/trunk groups 40a, 40b is not to be assumed in the majority of application scenarios, and line-group-internal connections between the line/trunk groups 40a, 40b are switched by means of the switching matrix 20 in the remotely located line unit. In these cases, connection control again takes place by means of the coordination processor (not shown) of the exchange 12. The user data assigned to the n line/trunk groups 40a, 40b is transmitted to the switching network 32 by means of a connection line a₁ to aₙ which is assigned to the relevant line/trunk group 40a, 40b.

A destination subscriber's call number which is selected by a first subscriber connected to the line/trunk group 40a is evaluated by the coordination processor, which is not shown in FIG. 3.

The coordination processor checks whether a through-connection of voice channels to the switching network 32 of the exchange 12 is required in order to set up the call, or whether the desired call can be set up by means of the switching matrix 20 of the remotely located line unit 14. If the coordination processor finds that the switching network 32 is necessary for the through-connection of the connection, a connection takes place via the switching network 32 as though the relevant line/trunk group 40a, 40b were directly connected to the switching network 32. From the set of m user data channels, the coordination processor then selects a free channel for transmitting the user data. By means of the switching matrices 20, 24, the selected user channel is through-connected onto the previously specified user data channel of the connection line b₁ to bₙ to the line/trunk group 40a, 40b, and onto the previously specified user data channel of the connection line a₁ to aₙ to the switching network 32. The message data associated with the connection is transmitted by means of the preset n+1 message data channels.

If through-connection of user data channels via the switching network 32 is not required, user data channels for the connection are through-connected by means of the switching matrix 20 in the remotely located line unit 14. Connections between subscribers which are serviced by the same line/trunk groups 40a or 40b are also switched by means of the switching matrix 20. The control unit 22 of the remotely located line unit 14 controls the switching matrix 20. The control processes required for this are initiated by the coordination processor of the exchange 12. The message data, in particular control data from the coordination processor and reports of the control units, are transmitted by means of the message data channels. A fixed number of message data channels are used for this purpose. At least one message data channel is preferably assigned and provided for each line/trunk group 40a, 40b, and one message data channel for each remotely located line unit 14.

The connection control of all connections, including connections between and within the line/trunk groups 40a and 40b, is managed by the coordination processor of the exchange 12. The control unit 22 of the remotely located line unit 14, and the control unit 26 for controlling the switching matrix 24 of the exchange 12, control the assignment of the n×k user data channels to the m transmission channels for user data between the exchange 12 and the remotely located line unit 14.

The coordination processor contains an exact image of the utilization of the user data channels which are available between the exchange 12 and the remotely located line unit 14, and the assignment of these channels to the switching network 32 and to the line/trunk groups 40a, 40b. Message data channels for transmitting control data are permanently through-connected between the message buffer system 36 and the transmission interface unit 18 by the switching network 32 of the exchange 12. A message data channel to a line/trunk group 40a, 40b can be transmitted, e.g. by means of a permanently predefined channel, between the transmission interface units 16, 18.

A message handling unit MH is located in the control unit 22 of the remotely located line unit 14 and in the control unit 26 of the transmission interface unit 18 of the exchange 12. The control data is through-connected to these message handling units MH. The message handling unit MH of the control unit 26 terminates the message data protocol between the switching network 32 and the line/trunk groups 40a, 40b, and converts this message data into a further protocol which is used to transmit the message data between the exchange 12 and the remotely located line unit 14. The message handling unit MH of the remotely located line unit 14 converts this message data back into the original message data protocol and transmits the message data to the line/trunk groups 40a, 40b by means of these protocols. In this way, the message handling unit MH of the control unit 22 takes responsibility for protocol control and protocol termination for the data transmission to the line/trunk groups 40a, 40b. The transmission of the control data from the switching matrix 20 to the line/trunk groups 40a, 40b therefore takes place again by means of the original data protocol to the relevant line/trunk group 40a, 40b. In further exemplary embodiments, the transmission of the message data between the exchange 12 and the remotely located line unit 14 can also take place by means of message data channels which are separate, both physically and in relation to transmission, from the user data channels.

As shown in FIG. 6, in a switching system 60 in accordance with the invention, the switching network 32 can be split into a real part 32a and a virtual part 32b. In a virtual part 32b of the switching network 32, the modules and/or the components are not physically present. The hardware addresses of the line/trunk groups 40a, 40b, which line/trunk groups are provided at these modules and/or components that are possible but not present, also serve as logical addresses for addressing the line/trunk groups 40a, 40b which are located in the remotely located line unit 14. The real part 32a designates that part of the switching network 32 which is constructed using physical components in the exchange 12. The line/trunk groups 34a, 34b, which are directly connected to the switching network 32, are attached to the real components 32a of the switching network 32. The message buffer unit 36 is also connected to the real part 32a of the switching network 32. The m transmission channels between the exchange 12 and the remotely located line unit 14 are connected by the switching matrix 24 to m data channels of the real switching network 32a. The virtual part 32b of the switching network 32 has non-present connections n, p+1 to the transmission interface unit 18, wherein the real connections 1, p provide at least m transmission channels and wherein the number of non-present transmission channels is derived from the difference between the totality of the transmission channels of all n line/trunk groups 40a, 40b and the m transmission channels.

The data which is transmitted between the exchange 12 and the remotely located line unit 14 by means of the m data channels from and to the line/trunk groups 40a, 40b is supplied to or taken from the real switching network 32a. Some of the line/trunk groups are assigned to the virtual switching network 32b. Connections between further line/trunk groups, e.g. the line/trunk groups 34a, 34b, and the line/trunk groups 40a, 40b which are assigned to the virtual switching network 32b, are established via the real parts 32a of the switching network 32. In this exemplary embodiment, the equipment configuration of the exchange 12 is also geared to the subscriber peripherals and connection line peripherals, but modules and racks of the virtual part 32b of the switching network 32 are not physically present.

The dimensioning of the size of the exchange 12 is based on the total number of attached line/trunk groups 40a, 40b, 34a, 34b. In particular, this relates to the dimensioning and embodiment of the coordination processor 38, the message buffer system 36 and the database of the exchange 12. The switching network 32 and the message buffer 36 are configured for the total number of attached line/trunk groups 40a, 40b, 34a, 34b in the database of the switching system 10.

Virtual parts 32b of the switching network 32 are not implemented in hardware, i.e. they are not installed or assembled. The known service functions are preserved for the operator. The plurality of interfaces of the administrative, operation-oriented and configuration-related software modules of the exchange 12 are retained. FIG. 6 shows an optimized switching network 32 for line/trunk groups 40a, 40b which are attached to a remotely located line unit 14. In this case, the virtual part 32b of the switching network 32 is shown with a light background. The real part 32a of the switching network 32 is shown with a dark background. The connection interfaces for the line/trunk groups 1 to p are configured to be real and the connection interfaces for the line/trunk groups p+l to n are configured to be virtual at the switching network 32.

FIG. 4 shows virtual and real parts of the switching network 32, together with real peripherals. The hardware components SNMUX 0 and SNMUX 1 are assigned a total of 252 line/trunk groups, and the virtual components SNMUX 2 and SNMUX 15, of which only SNMUX 14 and SNMUX 15 are shown, are assigned a total of 1764 line/trunk groups. These SNMUX components are peripheral components of the switching network. The real and virtual components are connected to a virtual central switching matrix MATM which has a virtual controller MATC. The real components of the exchange are shown with a dark background and the virtual components with a light background. Subunits SNMUX 2 to SNMUX 15 are virtual components of the switching network.

When setting up and configuring the exchange, a corresponding identification of the virtual components is made by means of an operator interface.

Administrative program modules perform validity checks on the operator inputs in the exchange. In this case, the components are identified as virtual components or as non-virtual components, and this identification is carried out by means of an attribute which is assigned to the component. For reasons of compatibility with earlier software versions of the exchange, this “virtual” attribute is designed as an optional parameter of the affected setup commands at the operator interface.

In the reports which are visible to operators and maintenance technicians, e.g. for displaying the hardware status of a unit, virtual units are identified in order to allow the simple and rapid error analysis and fault clearance at the exchange.

FIG. 5 shows the use of virtual parts of the switching network in three different upgrade levels. In some cases, the switching network is not physically present, i.e. not constructed in hardware. A switching network of an exchange 100 has one real component SNMUX 102 and one virtual component SNMUX 104. With these, it is possible to address a total of 252 line/trunk groups, wherein some of the line/trunk groups are attached in remotely located line units.

The exchange 110 has real components 112a, 112b and virtual components 114a, 114b, 116a, 116b and 118. 504 line/trunk groups can be attached to this exchange 110. 756 line/trunk groups can be attached to the exchange 120. In the case of the exchange 120, in contrast to the exchange 110, part of the switching matrix MATM is also required to be physically present, i.e. a part of the switching matrix is present in the form of modules and racks. Some of the line/trunk groups are attached via remotely located line units.

FIG. 7 shows a switching system 140 which has an exchange 144 and two remotely located line units 142, 143. A switching network 156 of the exchange 144 has a real part 156a and a virtual part 156b. The exchange 144 also has a coordination processor 160 and a message buffer system 158. A transmission interface unit 150 of the exchange 144 has a switching matrix 164 which is controlled by a control unit 162.

The remotely located line unit 146 has a switching matrix 172 and a control unit 174, and is connected by means of an interface unit 168 to an interface unit 166a of the exchange 144. Line/trunk groups 152a, 152b are attached to the switching matrix 172 of the remotely located line unit 146. The remotely located line unit 148 has a switching matrix 176 and a control unit 178, and is connected by means of an interface unit 170 to an interface unit 166b of the transmission interface unit 150 of the exchange 144. Line/trunk groups 154a, 154b are attached to the switching matrix 176 of the remotely located line unit 143.

The switching matrix 164 of the transmission interface unit 150 of the exchange 144 has connections to the real switching network 156a, whose data transmission capacity is less than the sum of the possible data transmission capacities of the line/trunk groups 152a, 152b, 154a, 154b. Each line/trunk group 152a, 152b, 154a, 154b is assigned an address which is defined by the switching network 156. The attachment of the switching matrix 164 to the switching network 156 takes place with a lower data transmission capacity than would be required for a direct attachment of the line/trunk groups 152a, 152b, 154a, 154b. The transmission of the user data to and from these line/trunk groups 152a, 152b, 154a, 154b takes place by means of the connections of the switching matrix 164 to the real part 156a of the switching network 156.

If a connection is required from a subscriber A (not shown), who is attached to the line/trunk group 152a, to a subscriber B (also not shown), who is attached to the line/trunk group 152b, the user data, e.g. voice data, is through-connected by means of the switching matrix 172. The connection control is carried out by the coordination processor 160 of the exchange 144. Transmission of user data from the remotely located line unit 142 to the exchange 144 and vice versa is not required. In particular, data transmission of user data to the switching network is not required. The same applies to connections between subscribers who are attached to the line/trunk group 154a and the line/trunk group 154b of the remotely located line unit 143.

If a connection is required from a subscriber C, for example, who is attached to the line/trunk group 152b, to a subscriber D, who is attached to the line/trunk group 154b, the user data can be through-connected in the switching matrix 164 without the need to through-connect user data connections to the switching network 156a.

As a result of switching connections in the switching matrices 172, 176, 164, the user data transmission to the switching network 156 is drastically reduced in comparison with the user data volume when switching all connections by means of the switching network 156, and therefore the number of user data channels between the switching network 156 and the transmission interface unit 150 is significantly reduced and a significant part of the switching network 156 of the exchange 144 can be configured virtually. In the case of a connection setup from a subscriber of a line/trunk group 152a, 152b, 154a, 154b to a subscriber who is attached to the line/trunk group 180, which is directly connected to the switching network 156, it is necessary to transmit user data by means of a connection line between the transmission interface unit 150 and the switching network 156. Data transmission of user data to and from the switching network 156 is also necessary if connections are required to subscribers who are attached to line/trunk groups in further remotely located line units.

FIG. 8 shows a further exemplary embodiment of a switching system. In this case, the switching system 200 shown in FIG. 8 contains the same elements as the switching system 50 which is shown in FIG. 3. Unlike FIG. 3, however, the switching network 32 is in part structured virtually. As explained above, the virtual part 32b of the switching network 32 is used in particular for addressing line/trunk groups 40a, 40b which are not directly connected to the switching network 32. Unlike FIG. 3, the switching matrix 24 has m user data connections to the real part 32a of the switching network 32. As explained above, the number of m user data channels between the switching matrix 24 and the real part 32a of the switching network 32 is less than the required n×k user data channels to the switching network 32. By means of the real switching network 32a, however, a message data connection exists to each line/trunk group. Furthermore, a message data connection exists to the control units 22 and 26 via the switching network 32. These message data connections are primarily used for transmitting control messages from and to the message buffer 36 and for the bidirectional transmission of reports.

1. An exchange for the switching of connections,
wherein the exchange (12) is connected to at least one remotely located line unit (RSU, 14) which has n line/trunk groups (LTG, 40a, 40b),
the connection between the remotely located line unit (RSU, 14) and the exchange (12) is established by means of a transmission interface unit (RTI, 16) of the remotely located line unit (RSU, 14) and a transmission interface unit (HTI, 18) of the exchange (12),
the connection between the exchange (12) and the remotely located line unit (RSU, 14) comprises p message data channels and m user data channels,
and wherein a connection exists between the transmission interface unit (HTI, 18) and a switching network (SN, 32) of the exchange (12),
characterized in that
the connection between the transmission interface unit (HTI, 18) and the switching network (SN, 32) of the exchange (12) comprises x user data channels, wherein the sum of the transmission capacities of these x user data channels is less than the sum of the transmission capacities of the user data channels of all n line/trunk groups (LTG, 40a, 40b).

2. The exchange as claimed in claim 1,
characterized in that
connections between and within the n line/trunk groups (LTG, 40a, 40b) are switched within the remotely located line unit (RSU, 14).

3. The exchange as claimed in one of the preceding claims,
characterized in that
each of the n line/trunk groups (LTG, 40a, 40b) has at least one message data channel, wherein the sum of the transmission capacities of the message data channels of the n line/trunk groups (LTG, 40a, 40b) is less than or equal to the sum of the data transmission capacities of the p message data channels between the transmission interface unit (HTI, 18) of the exchange (12) and the transmission interface unit (RTI, 16) of the remotely located line unit (RSU, 14).

4. The exchange as claimed in one of the preceding claims,
characterized in that
the transmission capacity of each user data channel is equal to a fixed basic data transmission capacity of the switching system (10).

5. The exchange as claimed in one of the preceding claims,
characterized in that
each of the n line/trunk groups (LTG, 40a, 40b) has exactly one message data channel, and that the transmission capacity of the message data channel of each line/trunk group is a multiple of a fixed basic data transmission capacity of the switching system (10), said multiple being defined for each line/trunk group.

6. The exchange as claimed in one of the preceding claims,
characterized in that
the data transmission capacity of the message data channel of each of the n line/trunk groups (LTG, 40a, 40b) is equal to a defined multiple of the basic data transmission rate of the switching system (10).

7. The exchange as claimed in one of the preceding claims,
characterized in that
each of the n line/trunk groups (LTG, 40a, 40b) of the remotely located line unit has a defined transmission capacity of k user data channels.

8. The exchange as claimed in one of the preceding claims,
characterized in that
message data which is transmitted by means of the message data channels contains control commands and reports which the remotely located line/trunk groups (LTG, 40a, 40b) exchange between themselves and with central components and further line/trunk groups (LTG, 34a, 34b) of the switching system (10).

9. The exchange as claimed in claim 8,
characterized in that
this message data serves to control switching-oriented, administrative and/or configuration-related events.

10. The exchange as claimed in one of the preceding claims,
characterized in that
the user data transmission between the transmission interface unit (RTI, 16) of the remotely located line unit (RSU, 14) and the transmission interface unit (HTI, 18) of the exchange (12) is controlled by means of two further message data channels, wherein message data which is transmitted by means of the first message data channel serves to control the transmission interface unit (HTI, 18) of the exchange (12), and wherein message data which is transmitted by means of the second message data channel serves to control the remotely located line unit (RSU, 14).

11. The exchange as claimed in one of the preceding claims,
characterized in that
the message data transmission takes place by means of the connection between the transmission interface unit (HTI, 18) of the exchange (12) and the transmission interface unit (RTI, 16) of the remotely located line unit (RSU, 14).

12. The exchange as claimed in one of the preceding claims,
characterized in that
the transmission method between the exchange (12) and the remotely located line unit (RSU, 14) takes place by means of a PCM30, PCM24, SDH or SONET transmission method.

13. The exchange as claimed in one of the preceding claims,
characterized in that
the message data which is transmitted from the remotely located line unit (RSU, 14) to the exchange (12) by means of the message data channels is transmitted to the message buffer system (MB, 36) of the exchange (12) by means of the transmission interface unit (HTI, 18) of the exchange (12), and that the message data which is to be transmitted from the message buffer (MB, 36) of the exchange (12) to the remotely located line unit (RSU, 14) by means of the message data channels is transmitted from the message buffer system (MB, 36) of the exchange (12) to the transmission interface unit (HTI, 18) of the exchange (12), by means of which it is transmitted onward to the remotely located line unit (RSU, 14).

14. The exchange as claimed in one of the preceding claims,
characterized in that
physical interfaces between the transmission interface unit (HTI, 18) of the exchange (12) and a message buffer system (MB, 36) of the exchange (12) are used for the transmission of message data by means of the message data channels.

15. The exchange as claimed in one of the claims 1 to 14,
characterized in that
an interface between the transmission interface unit (HTI, 18) of the exchange (12) and the switching network (SN, 32) is used for the transmission of message data by means of the message data channels.

16. The exchange as claimed in one of the preceding claims,
characterized in that
the switching network (SN, 32) switches bi-directional, permanently preset message data channels in order to transmit the message data between a message buffer system (MB, 36) and the transmission interface unit (HTI, 18) of the exchange (12).

17. The exchange as claimed in claim 16,
characterized in that
the available data transmission capacity between the switching network (SN, 32) and the transmission interface unit (HTI, 18) of the exchange (12) is at least equal to the sum of the transmission capacities of the p message data channels, of the message data channel of the transmission interface unit (HTI, 18) of the exchange (12), and of the x user data channels.

18. The exchange as claimed in one of the preceding claims,
characterized in that
the exchange (12) has at least two transmission interface units (HTI, 18), at least one of which is connected to at least two remotely located line units (RSU, 14).

19. The exchange as claimed in one of the preceding claims,
characterized in that
at least two remotely located line units (RSU, 14) can be attached by means of a transmission interface unit (HTI, 18) of the exchange (12), wherein the transmission interface unit (HTI, 18) of the exchange (12) has a switching matrix for switching user data connections between line/trunk groups (LTG, 40a, 40b) of the remotely located line units (RSU, 14) and switches the message data channels of the remotely located line units (RSU, 14), which are attached to the transmission interface unit (HTI, 18), to the message buffer system (MB, 36), and wherein the data transmission capacity of the user data channels between the transmission interface unit (HTI, 18) of the exchange (12) and the switching network (SN, 32) of the exchange (12) is less than the sum of the transmission capacities of the user data channels of the connections between the remotely located line units (RSU, 14) and the transmission interface unit (HTI, 18) of the exchange (12).

20. The exchange as claimed in one of the preceding claims,
characterized in that
a controller (CP, 38) of the exchange (12) works in accordance with a path-finding algorithm for determining a through-connection path of a connection which is to be switched, wherein said path-finding algorithm determines through-connection paths which are maintained within the remotely located line unit (RSU, 14) for the switching of connections between and within line/trunk groups (LTG, 40a, 40b) of the remotely located line unit (RSU, 14).

21. The exchange as claimed in one of the preceding claims,
characterized in that
a controller (CP, 38) of the exchange (12) works in accordance with a path-finding algorithm for determining a through-connection path of a connection which is to be switched, which path-finding algorithm prefers the switching of connections within the transmission interface unit (HTI, 18) of the exchange (12) if these connections are to be switched between line/trunk groups (LTG, 40a, 40b) on different remotely located line units (RSU) which are attached to the same transmission interface unit (HTI, 18).

22. The exchange as claimed in one of the preceding claims,
characterized in that
the upgrade of the switching network (SN, 32) of the exchange (12), which upgrade is defined in the database of the exchange, takes place as in the case of a direct attachment of all line/trunk groups (LTG, 40a, 40b, 34a, 34b) to the switching network (SN, 32), wherein a part (32b) of the switching network (SN, 32) of the exchange (12) is not upgraded physically, and wherein the transmission of the user data between the switching network (SN, 32) and those line/trunk groups (LTG, 34a, 34b) which are directly connected to the switching network (SN, 32) and those transmission interface units (HTI, 18) which are connected to the switching network (SN, 32) takes place by means of the physically upgraded part (32a) of the switching network (SN, 32).

23. The exchange as claimed in claim 22,
characterized in that
the physically non-upgraded parts (32b) of the switching network (SN, 32) are set up as virtual components of the switching network (SN, 32) via an operator interface of the exchange (12), and are identified in a database of the exchange (12) as virtual components.

24. The exchange as claimed in claim 22,
characterized in that
virtual components of the switching network (SN, 32) are identified as virtual in reports which are used for fault clearance on the exchange (12).

25. The exchange as claimed in claim 23 or 24,
characterized in that
the components of the switching network (SN, 32) which are identified as virtual are not started up in hardware during a startup or partial startup of the exchange (12), and that the setting up of line/trunk groups (LTG, 40a, 40b) which are assigned to these virtual parts (32b) of the switching network (SN, 32), and the startup of these line/trunk groups (LTG, 40a, 40b), is allowed if the line/trunk groups (LTG, 40a, 40b) are part of a remotely located line unit (RSU, 14).

26. The exchange as claimed in one of the preceding claims,
characterized in that
the message data channels of the line/trunk groups (LTG, 40a, 40b) are addressed by means of the address of their line location at the switching network (SN, 32), wherein line locations are permitted at virtual or physically upgraded components of the switching network (SN, 32).

27. The exchange as claimed in one of the claims 22 to 26,
characterized in that
when setting up or starting up a line/trunk group (LTG, 40a, 40b) of a remotely located line unit (RSU, 14) which is assigned to a virtual part (32b) of the switching network (SN, 32), the controller (CP, 38) of the exchange (12) searches by means of a path-finding algorithm for a free through-connecting path in the physically upgraded part of the switching network, for the message data channel between message buffer (MB, 36) and line/trunk group (LTG, 40a, 40b), through-connects this through-connecting path, permanently occupies said through-connecting path, and activates it at the startup of the line/trunk group (LTG, 40a, 40b) at the latest.

28. The exchange as claimed in one of the preceding claims,
characterized in that
the message data channels of the line/trunk groups (LTG, 40a, 40b) are
configured with redundancy such that, for each of the line/trunk groups (LTG, 40a, 40b) which are attached to the remotely located line unit (RSU, 14), at least two message data channels are switched by means of the transmission interface unit (RTI, 16) of the remotely located line unit (RSU, 14) and the transmission interface unit (HTI, 18) of the exchange (12).

29. The exchange as claimed in claim 28,
characterized in that
a connection exists in each case between the redundant parts of the switching network (SN, 32) and the transmission interface unit (HTI, 18) of the exchange (12), and that the transmission interface unit (HTI, 18) of the exchange (12) has one connection to each of the redundant parts of the message buffer (MB, 36).

30. The exchange as claimed in one of the preceding claims,
characterized in that
the transmission interface unit (RTI, 16) of the remotely located line unit (RSU, 14) is configured in duplicate for redundancy.

31. The exchange as claimed in one of the preceding claims,
characterized in that
a controller (CP, 38) of the exchange (12) works in accordance with a path-finding algorithm for switching-oriented through-connections, which path-finding algorithm, in order to through-connect a connection between a line/trunk group (LTG) of a remotely located line unit (RSU, 14) and a further line/trunk group (LTG) which cannot be reached via the same transmission interface unit (HTI, 18) of the exchange (12), searches for a transmission path via the non-virtual parts of the switching network (SN, 32), the participating transmission interface units (HTI, RTI), and free channels on the transmission links between the remotely located line unit and the exchange (12), occupies said transmission path, and issues corresponding configuration commands to the line/trunk groups (LTG), the transmission interface units (RTI, HTI, 16, 18) and the switching network (SN, 32).

32. A method for controlling an exchange,
wherein the exchange (12) is connected to at least one remotely located line unit (RSU, 14) which has n line/trunk groups (LTG, 40a, 40b),
the connection between the remotely located line unit (RSU, 14) and the exchange (12) is established by means of a transmission interface unit (RTI, 16) of the remotely located line unit (RSU, 14) and a transmission interface unit (HTI, 18) of the exchange (12),
the exchange (12) is connected to the remotely located line unit (RSU, 14) by means of p message data channels and m user data channels,
and wherein the transmission interface unit (HTI, 18) is connected to a switching network (SN, 32) of the exchange (12),
characterized in that
the transmission interface unit (HTI, 18) is connected to the switching network (SN, 32) of the exchange (12) by means of x user data channels, wherein the sum of the transmission capacities of these x user data channels is less than the sum of the transmission capacities of the user data channels of all n line/trunk groups (LTG, 40a, 40b).
